(19) United States
(12) Patent Application Publication
(10) Pub. No.: US 2026/0331508 A1
(43) Pub. Date: Oct. 22, 2026

(54) CURED PRODUCT FOR LITHIUM ION SECONDARY BATTERY, NEGATIVE ELECTRODE FOR LITHIUM ION SECONDARY BATTERY, AND LITHIUM ION SECONDARY BATTERY

(71) Applicant: TDK Corporation, Tokyo (JP)

(72) Inventors: Yuka MASUDA, Tokyo (JP); Atsushi MONDEN, Tokyo (JP); Tomomi IWAMOTO, Tokyo (JP); Ryosuke KIDO, Tokyo (JP)

(73) Assignee: TDK Corporation, Tokyo (JP)

(21) Appl. No.: 19/485,683

(22) PCT Filed: May 15, 2024
(86) PCT No.: PCT/JP2024/018036

§ 371 Date: Nov. 19, 2025

(30) Foreign Application Priority Data
May 24, 2023 (JP) 2023-085647

(51) Int. Cl. H01M 4/62; C08F 8/44; H01M 4/02; H01M 10/0525

(52) U.S. Cl. CPC H01M 4/622; C08F 8/44; H01M 10/0525; C08F 2810/20; H01M 2004/027

(57) ABSTRACT

A cured product for a lithium-ion secondary battery contains a water-soluble polymer crosslinked with a crosslinking agent. The water-soluble polymer has a carboxy group and a COOX group formed by ion exchange of a part of the carboxy groups. The crosslinking agent is a compound containing a metal capable of having a six-coordinate structure.

### TECHNICAL FIELD

The present invention relates to a cured product for a lithium ion secondary battery, a negative electrode for a lithium ion secondary battery, and a lithium ion secondary battery.

Priority is claimed on Japanese Patent Application No. 2023-085647, filed May 24, 2023, the content of which is incorporated herein by reference.

### BACKGROUND ART

A lithium ion secondary battery is widely used as a power source for a mobile device such as a mobile phone or a laptop computer, a hybrid car, or the like.

The capacity of the lithium ion secondary battery mainly depends on the active material of the electrode. Graphite is generally used as the negative electrode active material. However, there is a demand for a negative electrode active material that provides a higher capacity. For example, silicon (Si) is said to have a much larger theoretical capacity as compared with the theoretical capacity of graphite (372 mAh/g).

A negative electrode active material containing Si undergoes a large volume expansion during charging. The volume expansion of the negative electrode active material causes the deterioration of the cycle characteristics of the battery. In a case where the volume expansion of the negative electrode active material occurs, the decomposition or the like of the electrolytic solution may occur since, for example, cracking occurs in the negative electrode active material, peeling occurs at the interface between the negative electrode active material layer and the current collector, or cracking occurs in the solid electrolyte interphase (SEI) film. These deteriorate the cycle characteristics of the battery.

For example, Patent Document 1 discloses a binder in which a water-soluble polymer containing a carboxy group is crosslinked with a water-soluble crosslinking agent. This binder follows the volume change of the negative electrode active material associated with charging and discharging, and provides excellent cycle characteristics for a battery using this binder.

### CITATION LIST

### Patent Document

[Patent Document 1] Japanese Patent No. 6961939

### SUMMARY OF THE INVENTION

### Technical Problem

There is a demand for further improvement of the cycle characteristics.

The present disclosure has been made in consideration of the above problems, and an object of the present disclosure is to provide a cured product for a lithium ion secondary battery, which is capable of improving the cycle characteristics of a lithium ion secondary battery.

### Solution to Problem

In order to solve the above problems, the following means are provided.
(1) A cured product for a lithium ion secondary battery according to a first aspect is a cured product for a lithium ion secondary battery, which contains a water-soluble polymer that is crosslinked with a crosslinking agent, where the water-soluble polymer has a carboxy group and a COOX group that is obtained by subjecting a part of carboxy groups to ion exchange, and the crosslinking agent is a compound which contains a metal that is capable of having a six-coordinate structure.
(2) In the cured product for a lithium ion secondary battery according to the above aspect, the metal that is capable of having the six-coordinate structure may be any one selected from the group consisting of titanium, zirconium, chromium, manganese, cobalt, and nickel.
(3) In the cured product for a lithium ion secondary battery according to the above aspect, the metal that is capable of having the six-coordinate structure may be titanium or zirconium.
(4) In the cured product for a lithium ion secondary battery according to the above aspect, an ion exchange rate of the water-soluble polymer may be 50% or more and less than 90%. The ion exchange rate is defined as the ratio of the COOX groups to a total number of the carboxy group and COOX group.
(5) The cured product for a lithium ion secondary battery according to the above aspect may contain 0.1 parts by mass or more and 10 parts by mass or less of the crosslinking agent with respect to 100 parts by mass of the water-soluble polymer.
(6) In the cured product for a lithium ion secondary battery according to the above aspect, a liquid absorption rate after immersion for a week in an electrolytic solution obtained by adding 1 mol/L of LiPF₆ to a non-aqueous solvent containing ethylene carbonate and diethyl carbonate may be −5% or more and less than 15%.
(7) The negative electrode for a lithium ion secondary battery according to a second aspect has a negative electrode active material and the cured product for a secondary battery according to the above aspect.
(8) A lithium ion secondary battery according to a third aspect includes a negative electrode for a lithium ion secondary battery, a positive electrode, and a separator present between the negative electrode for a lithium ion secondary battery according to the above aspect and the positive electrode.

### Advantages Effects of Invention

The cured product for a lithium ion secondary battery according to the above aspect improves cycle characteristics of the lithium ion secondary battery.

### BRIEF DESCRIPTION OF THE DRAWINGS

FIG. 1 is a schematic view of a lithium ion secondary battery according to a first embodiment,

FIG. 2 is a schematic view of a binder according to the first embodiment.

FIG. 3 is a schematic view before crosslinking of the binder according to the first embodiment.

### DESCRIPTION OF EMBODIMENTS

Hereinafter, the embodiments will be described in detail with reference to the drawings as appropriate. The drawings that are used in the following description may show characteristic portions in an enlarged scale for the sake of convenience in order to facilitate the understanding of the characteristics, and thus the dimensional ratios or the like of the respective constitutional elements may differ from the actual ones. The materials, dimensions, and the like, which are exemplified in the following description, are merely examples, and the present invention is not limited thereto. Therefore, an appropriate modification can be made within the scope that does not deviate from the gist of the present invention.

### “Lithium Ion Secondary Battery”

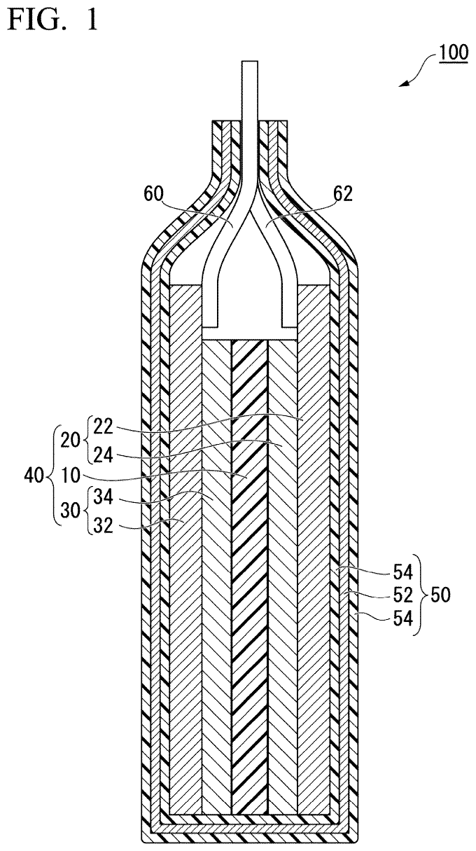

FIG. 1 is a schematic view of a lithium ion secondary battery according to a first embodiment. A lithium ion secondary battery 100 shown in FIG. 1 includes a power generation element 40, an exterior body 50, and a non-aqueous electrolytic solution (not shown in the drawing). The exterior body 50 coats the periphery of the power generation element 40. The power generation element 40 is connected to the outside by a pair of terminals 60 and 62, which are connected to the power generation element 40. The non-aqueous electrolytic solution is accommodated within the exterior body 50. Although FIG. 1 illustrates, as an example, a case in which one power generation element 40 is provided within the exterior body 50, a plurality of power generation elements 40 may be laminated. In addition, the lithium ion secondary battery 100 may have any shape of a cylinder shape, a square shape, a laminate shape, a button shape, or the like.

### (Power Generation Element)

The power generation element 40 includes a separator 10, a positive electrode 20, and a negative electrode 30.

### <Positive Electrode>

The positive electrode 20 has, for example, a positive electrode current collector 22 and a positive electrode active material layer 24. The positive electrode active material layer 24 is in contact with at least one surface of the positive electrode current collector 22.

[Positive electrode current collector] The positive electrode current collector 22 is, for example, a conductive plate material. The positive electrode current collector 22 is a thin plate of a metal, for example, aluminum, copper, nickel, titanium, or stainless steel. Aluminum, which is light weight, is suitably used for the positive electrode current collector 22. The average thickness of the positive electrode current collector 22 is, for example, 10 μm or more and 30 μm or less.

[Positive electrode active material layer] The positive electrode active material layer 24 contains, for example, a positive electrode active material. The positive electrode active material layer 24 may contain a conductive auxiliary agent and a binder as necessary.

The positive electrode active material includes an electrode active material that enables the reversible proceeding of absorbing and releasing of lithium ions, desorbing and inserting (intercalating) of lithium ions, or doping and dedoping of lithium ions and counter anions.

The positive electrode active material is, for example, a composite metal oxide. The composite metal oxide is, for example, lithium cobaltate (LiCoO₂), lithium nickelate (LiNiO₂), lithium manganate (LiMnO₂), and lithium manganese spinel (LiMn₂O₄), as well as a compound of a general formula: LiNiₓCo_{y}Mn_{z}MₐO₂ (in the general formula, x+y+z+a=1, 0≤x<1, 0≤y<1, 0≤z<1, and 0≤a<1 are satisfied, and M is one or more kinds of elements selected from Al, Mg, Nb, Ti, Cu, Zn, and Cr), a lithium vanadium compound (LiV₂O₅), an olivine-kind LiMPO₄ (here, M represents one or more kinds of elements selected from Co, Ni, Mn, Fe, Mg, Nb, Ti, Al, and Zr, or VO), lithium titanate (Li₄Ti₂O₁₂), and LiNiₓCo_{y}Al_{z}O₂ (0.9<x+y+z<1.1). The positive electrode active material may be an organic substance. For example, the positive electrode active material may be polyacetylene, polyaniline, polypyrrole, polythiophene, or polyacene.

The positive electrode active material may be a lithium-free material. Examples of the lithium-free material include FeF₃, a conjugated polymer containing an organic conductive substance, a Chevrel phase compound, a transition metal chalcogenide, a vanadium oxide, and a niobium oxide. As the lithium-free material, any one material described above may be used alone, or a plurality of the materials described above may be used in combination. In a case where the positive electrode active material is a lithium-free material, for example, an initial discharge is performed Lithium is inserted into the positive electrode active material by discharging. In addition, the positive electrode active material may be such that a lithium-free material is subjected to pre-doping with lithium chemically or electrochemically.

The conductive auxiliary agent enhances electron conductivity between the positive electrode active materials. The conductive auxiliary agent is, for example, a carbon powder, a carbon nanotube, a carbon material, a fine metal powder, a mixture of a carbon material and a fine metal powder, or a conductive oxide. Examples of the carbon powder include carbon black, acetylene black, and Ketjen black. The fine metal powder is, for example, a powder of copper, nickel, stainless steel, or iron.

The content of the conductive auxiliary agent in the positive electrode active material layer 24 is not particularly limited. For example, with respect to the total mass of the positive electrode active material, the conductive auxiliary agent, and the binder, the content of the conductive auxiliary agent is 0.5% by mass or more and 20% by mass or less and is preferably 1% by mass or more and 5% by mass or less.

The binder in the positive electrode active material layer 24 binds the positive electrode active materials to each other. As the binder, a publicly known binder can be used. The binder may be the same one as that in the negative electrode active material layer 34, which will be described later. The binder is preferably such as one that is insoluble in the electrolytic solution, has oxidation resistance, and has adhesiveness. The binder is, for example, a fluororesin. The binder is, for example, polyvinylidene fluoride (PVDF), polytetrafluoroethylene (PTFE), polyamide (PA), polyimide (PI), polyamideimide (PAI), polybenzimidazole (PBI), polyethersulfone (PES), a polyacrylic acid and a copolymer thereof, metal ion-crosslinked products of a polyacrylic acid and a copolymer thereof, polypropylene (PP) or polyethylene (PE) which is grafted with maleic anhydride, or a mixture thereof. The binder that is used in the positive electrode active material layer is particularly preferably PVDF.

The content of the binder in the positive electrode active material layer 24 is not particularly limited. For example, with respect to the total mass of the positive electrode active material, the conductive auxiliary agent, and the binder, the content of the binder is 1% by mass or more and 15% by mass or less and is preferably 1.5% by mass or more and 5% by mass or less. In a case where the binder content is low, the adhesion strength of the positive electrode 20 is weakened. In a case where the binder content is high, the energy density of the lithium ion secondary battery 100 decreases since the binder is electrochemically inactive and thus does not contribute to the discharge capacity.

### <Negative Electrode>

The negative electrode 30 has, for example, a negative electrode current collector 32 and a negative electrode active material layer 34. The negative electrode active material layer 34 is formed on at least one surface of the negative electrode current collector 32. The negative electrode 30 is an example of the negative electrode for a lithium ion secondary battery.

[Negative electrode current collector] The negative electrode current collector 32 is, for example, a conductive plate material. As the negative electrode current collector 32, the same one as that in the positive electrode current collector 22 can be used.

[Negative electrode active material layer] The negative electrode active material layer 34 contains a negative electrode active material and a binder. The negative electrode active material layer 34 may contain a conductive auxiliary agent as necessary. The binder is an example of the cured product for a lithium ion secondary battery.

The negative electrode active material includes silicon or a silicon compound. The silicon compound is, for example, a silicon alloy, a silicon oxide, or the like. For example, the silicon or the silicon compound may be such as one that is crystalline, noncrystalline, or may be silicon or a silicon compound, which is obtained by dispersing a crystalline silicon or silicon compound in the noncrystalline silicon or silicon compound. The noncrystalline silicon or silicon compound can be produced by a melt spinning method, a gas atomization method, or the like. The negative electrode active material may be a publicly known negative electrode active material other than silicon or the silicon compound.

The silicon alloy is represented by XₙSi. X is a cation. Examples of X include Ba, Mg, Al, Zn, Sn, Ca, V, Cr, Mn, Fe, Co, Ni, Cu, Zn, Ge, Y, Zr, Nb, Mo, W, Au, Ti, Na, and K. n satisfies 0≤n≤0.5. The silicon oxide is denoted as SiOₓ. x satisfies, for example, 0.8≤x≤2. The silicon oxide may consist of only SiO₂, may consist of only SiOₓ or may be a mixture of SiO and SiO₂. In addition, the silicon oxide may be such that some oxygen is deficient.

The negative electrode active material may be a composite of silicon or a composite of a silicon compound. The composite is such as one that is obtained by coating, with a conductive material, at least a part of the surface of the particle of the silicon or silicon compound. Examples of the conductive material include a carbon material, Al, Ti, Fe, Ni, Cu, Zn, Ag, and Sn. For example, a silicon carbon composite material (Si—C) is an example of the composite. The coating amount of the conductive material with respect to the particles of the silicon or silicon compound is, for example, 0.01% by mass to 30% by mass and preferably 0.1% by mass to 20% by mass with respect to the total mass of the composite. The composite can be produced by, for example, a mechanical alloying method, a chemical vapor deposition method, a wet method, a method of coating a polymer and then thermally decomposing and carbonizing the polymer, or the like.

A specific surface area of the negative electrode active material, which is determined by a BET method, is, for example, 0.5 m²/g or more and 100 m²/g or less, and preferably 1.0 m²/g or more and 20 m²/g or less. In a case where the specific surface area is small, Li ions are less likely to be inserted and desorbed between the negative electrode active materials. In a case where the specific surface area is large, a large quantity of binders is required for making an electrode, and thus the capacity per unit volume is reduced.

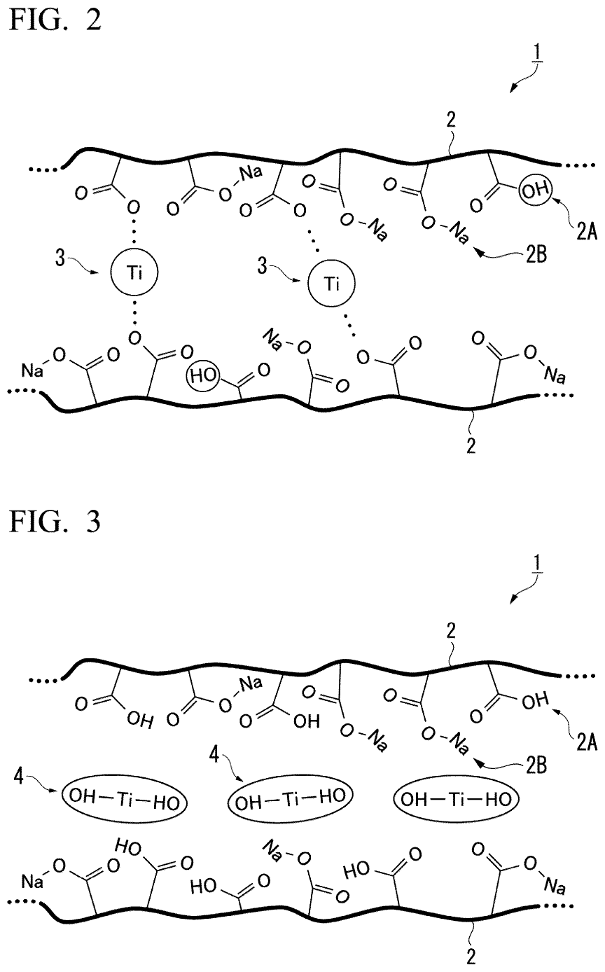

The binder adheres to the surface of the negative electrode active material, and binds the negative electrode active materials to each other and the negative electrode active material to the negative electrode current collector. FIG. 2 is a schematic view of a binder 1 according to the first embodiment. The binder 1 has a water-soluble polymer 2 and a crosslinking agent 3. The binder 1 is a binder obtained by crosslinking the water-soluble polymer 2 with the crosslinking agent 3. In a case where the binder 1 undergoes curing, it adheres to the surface of the negative electrode active material.

The water-soluble polymer 2 is, for example, a polymer having a carboxy group, a part of which has been subjected to ion exchange. The water-soluble polymer 2 has, for example, a carboxy group 2A and a COOX group 2B in which a part of carboxy groups has been substituted. The COOX group 2B is a carboxylate in which the hydrogen of the carboxy group has been exchanged with a cation. The cation for ion exchange with a part of the carboxy groups is, for example, Li, Na, or K. X of the COOX group is, for example, Li, Na, or K.

In the water-soluble polymer 2, for example, 50% or more and less than 90% of the carboxy group has been subjected to ion exchange. In other words, the ion exchange rate of the water-soluble polymer 2 is preferably 50% or more and less than 90%, and more preferably 60% or more and 80% or less. The ion exchange rate is a proportion of the COOX group 2B to the total of the carboxy group 2A and the COOX group 2B obtained by subjecting a part of carboxy groups to ion exchange.

By ion exchange of a part of the carboxy groups in the water-soluble polymer 2 to the COOX group 2B, the intramolecular crosslinking of the water-soluble polymer 2 can be suppressed. In a case where the water-soluble polymer 2 undergoes intramolecular crosslinking, the water-soluble polymer 2 undergoes gelation, which deteriorates the function of the binder 1. In addition, in a case where the water-soluble polymer 2 has the COOX group 2B, the COOX group 2B functions as a catalyst for a crosslinking reaction and promotes crosslinking between molecular chains of the water-soluble polymer 2.

In addition, the carboxy group 2A is responsible for binding to the negative electrode active material and crosslinking with the crosslinking agent 3. Therefore, the carboxy group 2A which has not been subjected to ion exchange is present in the binder 1, which enhances the binding properties between the binder 1 and the negative electrode active material and allows the binder 1 to have a network structure. The proportion of ion-exchanged carboxy groups in the water-soluble polymer 2 can be determined from the amount of consumed alkali required for the hydrolysis of the copolymerization unit, or by the composition analysis by nuclear magnetic resonance (NMR).

The water-soluble polymer 2 is, for example, polyacrylic acid, carboxymethyl cellulose, a copolymer of acrylic acid and vinyl alcohol, a copolymer of sodium acrylate and vinyl alcohol, sodium carboxymethyl cellulose, polynorbornene dicarboxylic acid, and polymethacrylic acid. One kind of the water-soluble polymer 2 may be used alone, or a plurality of kinds thereof may be used in combination.

A weight average molecular weight of the water-soluble polymer 2 is, for example, 25,000 to 640,000. In a case where the molecular weight of the water-soluble polymer 2 is small, the number of crosslinking points for crosslinking the water-soluble polymers 2 with each other is reduced, and the elasticity of the binder 1 after crosslinking is reduced. In a case where the molecular weight of the water-soluble polymer 2 is large, the binder 1 undergoes gelation, which makes uniform dispersion difficult. The weight average molecular weight of the water-soluble polymer 2 is determined by analyzing the water-soluble polymer before crosslinking in a case where the water-soluble polymer 2 before crosslinking is available. The weight average molecular weight of the water-soluble polymer 2 can be estimated from the weight average molecular weight of the binder 1 and the presence ratio of the water-soluble polymer 2 to the crosslinking agent 3 in the binder 1 in a case where the water-soluble polymer 2 before crosslinking is not available.

Here, whether or not a polymer is “water soluble” can be determined according to the following procedure. First, a mixture which is obtained by adding 1 part by mass (equivalent to the solid content) per 100 parts by mass of the ion exchange water and then carrying out stirring is prepared. The mixture is adjusted to a temperature of 20° C. to 95° C. and one condition within a range of a pH of 3 to 12 (a NaOH aqueous solution and/or a HCl aqueous solution is used for pH adjustment). Next, the mixture is passed through a screen of 250 mesh. In a case where the weight of the solid content of the residue remaining on the screen without passing through the screen does not exceed 50% by weight with respect to the solid content of the added polymer, it can be said that the polymer is water-soluble. It is noted that, even in an emulsion state in which the mixture of the polymer and the water is separated into two phases in a case of being allowed to stand, the polymer is water-soluble in a case where the definition above described is satisfied.

The crosslinking agent 3 carries out crosslinking between the water-soluble polymers 2. The crosslinking agent 3 is a compound containing a metal that is capable of having a six-coordinate structure. The metal that is capable of having a six-coordinate structure is any one selected from the group consisting of titanium, zirconium, chromium, manganese, cobalt, and nickel. The metal that is capable of having a six-coordinate structure is preferably titanium or zirconium.

FIG. 2 illustrates an example of a compound in which the crosslinking agent 3 contains titanium. The crosslinking agent 3 has a metal-oxygen bond in a portion for bonding to the water-soluble polymer 2. The metal-oxygen bond is strong, and thus the crosslinking agent 3 strongly crosslinks the water-soluble polymers 2 to each other.

FIG. 3 is a schematic view before crosslinking of the binder according to the first embodiment. FIG. 3 illustrates an example of a compound in which a crosslinking precursor 4 contains titanium. Although described in a simplified manner in FIG. 3, for example, Chemical Formula (1) below is a chemical structural formula of the crosslinking precursor 4 in a case where the metal that is capable of having a six-coordinate structure is titanium.

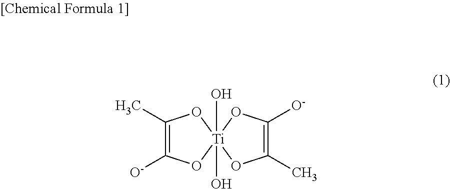

For example, in a case where a carboxy group of the water-soluble polymer 2 is reacted with a hydroxyl group of the crosslinking precursor 4, the water-soluble polymers 2 are crosslinked to each other by the crosslinking agent 3. In Chemical Formula (1) described above, two hydroxyl groups of the crosslinking precursor 4 undergo metal-oxygen bonding to the water-soluble polymer 2.

A part of the carboxy groups of the water-soluble polymer 2 remain unreacted without reacting with the crosslinking precursor 4. In a case where the remaining carboxy group interacts with the negative electrode active material, the binding properties between the negative electrode active material and the binder 1 are improved. Here, an example in which carboxy groups react and bind to each other is shown; however, the bond between the water-soluble polymer 2 and the crosslinking precursor 4 is not limited to this example. For example, an alkoxy group of the crosslinking precursor 4 may be eliminated and reacted with a hydroxyl group of the water-soluble polymer 2. In addition, for example, an isocyanate group, a carboxy group, or the like of the crosslinking precursor 4, and a carboxy group of the water-soluble polymer 2 may undergo a bonding reaction.

The crosslinking precursor 4 is a compound containing, in the structure, a metal that is capable of having a six-coordinate structure. The metal that is capable of having a six-coordinate structure is any one selected from the group consisting of titanium, zirconium, chromium, manganese, cobalt, and nickel. The metal that is capable of having a six-coordinate structure is preferably titanium or zirconium.

The crosslinking precursor 4 is, for example, an organic metal compound containing a metal that is capable of having a six-coordinate structure. For example, a case where the metal that is capable of having a six-coordinate structure is titanium or zirconium is shown as an example. Here, a specific example in a case where the metal is titanium or zirconium is shown as an example; however, the same compound can be used as the crosslinking precursor 4 even in a case where the metal that is capable of having a six-coordinate structure is chromium, manganese, cobalt, or nickel.

The titanium compound containing titanium is an organic titanium compound, and examples thereof include a titanium chelate. Examples of the titanium compound include titanium lactate, titanium triethanol aminate, a titanium lactate ammonium salt, titanium diethanol aminate, titanium aminoethyl amino ethanolate, and the like. The zirconium compound containing zirconium is an organic zirconium compound, and examples thereof include a zirconium chelate. Examples of the zirconium compound include zirconium lactate, zirconium triethanol aminate, a zirconium lactate ammonium salt, zirconium diethanol aminate, zirconium aminoethyl amino ethanolate, and the like. For example, an organic titanium compound, an organic zirconium compound, or the like, manufactured by Matsumoto Fine Chemical Co., Ltd., can be used as the crosslinking precursor 4.

The crosslinking precursor 4 reacts with a carboxy group of the water-soluble polymer 2 to form the crosslinking agent 3 that connects the water-soluble polymers 2 to each other. The crosslinking agent 3 containing a metal compound is compact, and in a case where the water-soluble polymer 2 is crosslinked using this crosslinking agent 3, the crystallinity of the water-soluble polymer 2 is easily maintained.

For example, the crosslinking agent 3 is 0.1 parts by mass or more and less than 10 parts by mass, preferably 0.1 parts by mass or more and 9.8 parts by mass or less, and more preferably 0.5 parts by mass or more and 3.1 parts by mass or less, with respect to 100 parts by mass of the water-soluble polymer 2. The mass ratio of the crosslinking agent 3 to the water-soluble polymer 2 is equivalent to an adding amount of the crosslinking precursor 4 with respect to the water-soluble polymer 2 before crosslinking.

The fact that the presence ratio of the crosslinking agent 3 in the binder 1 is small means that the number of crosslinking points for crosslinking the water-soluble polymers 2 to each other is small in the binder 1. In a case where the number of crosslinking points in the binder 1 is small, the elasticity of the binder 1 is reduced. In addition, the fact that the presence ratio of the crosslinking agent 3 is large means that there are many crosslinking points in the binder 1, and it is considered that the water-soluble polymer 2 has undergone intramolecular crosslinking. In a case where the water-soluble polymer 2 undergoes intramolecular crosslinking, the viscosity of the binder 1 is increased, or the binder 1 undergoes gelation, and thus the function of the binder 1 is deteriorated. In addition, in a case where the crosslinking agent 3 has a large presence ratio, the proportion of the carboxy groups that is capable of being present freely in the binder 1 is reduced, and the binding properties between the negative electrode active material and the binder 1 and between the negative electrode current collector 32 and the binder 1 is reduced.

The mass ratio between the crosslinking agent 3 and the water-soluble polymer 2 in the binder 1 can be determined from the mass ratio between the water-soluble polymer 2 and the crosslinking precursor 4 in the binder precursor solution in a case where a binder precursor solution before a crosslinking reaction, in which the water-soluble polymer 2 and the crosslinking precursor 4 are mixed, is available.

In a case of determining the mass ratio between the crosslinking agent 3 and the water-soluble polymer 2 from a lithium ion secondary battery containing the binder 1 after the crosslinking reaction, the determination is carried out, for example, according to the following procedure. First, the binder 1 is separated from a lithium ion secondary battery 1. The negative electrode 30 from which the electrolytic solution has been removed is impregnated with water, and then the resultant dissolution solution is dried, whereby the binder 1 can be extracted as a solid. The binder 1 extracted as a solid is analyzed by, for example, Fourier transform infrared spectroscopy (FT-IR). The water-soluble polymer 2, which is a main component in the binder 1, is identified by the analysis. Next, the mass ratio between the crosslinking agent 3 and the water-soluble polymer 2 is determined from the binder 1. The mass ratio therebetween can be determined by, for example, carrying out a data comparison between the results obtained by subjecting the extracted binder 1 to measurement by a thermal gravity-differential thermal analysis (TG-DTA), and the results obtained by carrying out a TG-DTA measurement using, as a standard sample, a polymer material (the water-soluble polymer 2) which is a main component, where the polymer material is identified in the above-described FT-IR analysis or the like. The water-soluble polymer 2 and the crosslinking agent 3 have decomposition temperatures different from each other, and thus the quantitative analysis of the binder 1 is possible by the TG-DTA measurement.

In a case where the amount of the crosslinking agent is very small and thus it is difficult to carry out the TG-DTA measurement, the qualitative analysis and quantitative analysis of the crosslinking agent may be carried out using gas chromatography mass spectrometry (GC/MS), high-speed liquid chromatography/photodiode array detection (LC/PDA), liquid chromatography mass spectrometry (LC/MS), or the like. Depending on the characteristics of the crosslinking agent, each chromatography may be combined with an appropriate detection method (for example, MS, hydrogen flame ionization detection, barrier discharge detection, fluorescence detection, differential refractive index detection, GC/quadrupole-time-of-flight mass spectrometry (Q-TOFMS), liquid chromatography quadrupole time-of-flight type mass spectrometry (LC/Q-TOFMS), or the like).

The liquid absorption rate of the binder 1 is, for example, −5% or more and less than 15%. The liquid absorption rate is a liquid absorption rate after immersion for a week in an electrolytic solution obtained by adding 1 mol/L of LiPF₆ to a non-aqueous solvent containing ethylene carbonate and diethyl carbonate. The liquid absorption rate is determined according to the following relational expression from the weight of the binder 1 before the immersion in the electrolytic solution and the weight of the binder 1 after immersion in the electrolyte.

Liquid absorption rate (%)=100−(“weight of binder after immersion in electrolytic solution and drying”/“weight of binder before immersion in electrolytic solution”×100)

First, the weight of the binder 1 before immersion in the electrolytic solution is measured. Next, an electrolytic solution, which is obtained by dissolving LiPF₆ as an electrolyte to a concentration of 1 mol/L in a mixture solvent obtained by mixing ethylene carbonate (EC) and diethyl carbonate (DEC) to have a volume ratio of EC:DEC=3:7, is prepared. The binder 1 is immersed in this electrolytic solution at 25° C. for one week. In a case where the binder 1 is immersed in the electrolytic solution for one week at 25° C., the binder 1 is in a saturated liquid absorption state. The saturated liquid absorption state refers to a state in which the weight of a cured product hardly changes even in a case where the cured product is immersed in a larger amount of the electrolytic solution. Then, the binder 1 after immersion is dried and wiped. Then, the weight of the binder 1 after drying is measured.

The liquid absorption rate indicates a negative value in a case where the binder 1 is dissolved in the electrolytic solution, and it indicates a positive value in a case where the binder 1 absorbs the electrolytic solution. In a case where the liquid absorption rate of the binder 1 is in the above-described range, the binder 1 is hardly dissolved or swollen in the electrolytic solution and thus is stable.

The content of the binder 1 in the negative electrode active material layer 34 is not particularly limited. For example, with respect to the total mass of the negative electrode active material, the conductive auxiliary agent, and the binder 1, the content of the binder 1 is 0.5% by mass or more and 20% by mass or less and is preferably 5% by mass or more and 15% by mass or less. In a case where the content of the binder 1 is low, the adhesion strength of the negative electrode 30 is weakened. In a case where the content of the binder 1 is high, the energy density of the lithium ion secondary battery 100 decreases since the binder 1 is electrochemically inactive and thus does not contribute to the discharge capacity.

The conductive auxiliary agent in the negative electrode active material layer 34 enhances electron conductivity between the negative electrode active materials. As the conductive auxiliary agent, the same one as that in the positive electrode active material layer 24 can be used.

The content of the conductive auxiliary agent in the negative electrode active material layer 34 is not particularly limited. For example, with respect to the total mass of the negative electrode active material, the conductive auxiliary agent, and the binder, the content of the conductive auxiliary agent is 5% by mass or more and 20% by mass or less and is preferably 1% by mass or more and 12% by mass or less.

### <Separator>

The separator 10 is sandwiched between the positive electrode 20 and the negative electrode 30. The separator 10 separates the positive electrode 20 from the negative electrode 30 and prevents a short circuit between the positive electrode 20 and the negative electrode 30. The separator 10 extends in-plane along the positive electrode 20 and the negative electrode 30. Lithium ions can pass through the separator 10.

The separator 10 has, for example, a porous structure having electrical insulating properties. The separator 10 is, for example, a single layered body or laminate of a polyolefin film. The separator 10 may be a stretched film of a mixture of polyethylene, polypropylene, or the like. The separator 10 may be a fibrous nonwoven fabric made of at least one constitutional material selected from the group consisting of cellulose, polyester, polyacrylonitrile, polyamide, polyethylene, and polypropylene. The separator 10 may be, for example, a solid electrolyte. The solid electrolyte is, for example, a polymer solid electrolyte, an oxide-based solid electrolyte, or a sulfide-based solid electrolyte. The separator 10 may be an inorganic coated separator. The inorganic coated separator is such as one that is obtained by coating the surface of the above-described film with a mixture of a resin such as PVDF or CMC and an inorganic substance such as alumina or silica. The inorganic coated separator has an excellent heat resistance and suppresses the precipitation of transition metals eluted from the positive electrode, onto the surface of the negative electrode.

### <Electrolytic Solution>

The electrolytic solution is enclosed in the exterior body 50, and the power generation element 40 is impregnated with the electrolytic solution. The non-aqueous electrolytic solution contains, for example, a non-aqueous solvent and an electrolytic salt. The electrolytic salt is dissolved in a non-aqueous solvent.

As the electrolytic solution, a publicly known electrolytic solution may be used. The electrolytic solution includes, for example, a non-aqueous solvent and an electrolyte salt.

The electrolytic salt is, for example, a lithium salt. Examples of the electrolyte include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, and LiN(FSO₂)₂.

One kind of lithium salt may be used alone, or two or more thereof may be used in combination. From the viewpoint of the degree of ionization, the electrolyte preferably contains LiPF₆. The concentration of the electrolytic salt is, for example, 0.8 mol/L or more and 5.0 mol/L or less.

The non-aqueous solvent is, for example, an aprotic organic solvent. The organic solvent includes, for example, a cyclic carbonate, a chain-like carbonate, an ether, a mixture thereof, and the like. Alternatively, the solvent may be an ionic liquid.

The cyclic carbonate solvates the electrolyte. The cyclic carbonate includes, for example, ethylene carbonate, propylene carbonate, butylene carbonate, and fluoroethylene carbonate. It is preferable that the cyclic carbonate includes at least fluoroethylene carbonate. Fluoroethylene carbonate (FEC) has a high redox potential and is easily reduced and decomposed. In a case where a part of the fluoroethylene carbonate (FEC) is reduced and decomposed, the electrolyte and the remaining solvent in the electrolytic solution are less likely to be decomposed. In addition, the fluoroethylene carbonate (FEC) forms a thin and stable coating film (SEI coating film) on the entire surface of the negative electrode active material at the initial stage of use of the lithium ion secondary battery. The SEI film prevents direct contact between the negative electrode active material and the electrolytic solution and prevents the decomposition of the electrolytic solution.

A chain-like carbonate reduces the viscosity of the cyclic carbonate. Examples of the chain-like carbonate include diethyl carbonate, dimethyl carbonate, and ethyl methyl carbonate. As the non-aqueous solvent, others such as methyl acetate, ethyl acetate, methyl propionate, ethyl propionate, propyl propionate, γ-butyrolactone, 1,2-dimethoxyethane, and 1,2-diethoxyethane may be contained.

In addition, the electrolytic solution may have a solid electrolyte interface (SEI) forming material, a surfactant, and the like. The additive includes, for example, vinyl carbonate, vinyl ethylene carbonate, phenyl ethylene carbonate, a succinic acid anhydride, lithium bisoxalate, lithium tetrafluoroborate, a dinitrile compound, propane sultone, butane sultone, propene sultone, 3-sulfolane, a fluorinated allyl ether, a fluorinated acrylate, and the like.

### <Exterior Body>

The exterior body 50 seals, in the inside thereof, the power generation element 40 and the non-aqueous electrolytic solution. The exterior body 50 suppresses the leakage of the non-aqueous electrolytic solution to the outside, the infiltration of moisture or the like into the inside of the lithium ion secondary battery 100 from the outside.

As shown in FIG. 1, the exterior body 50 has, for example, a metal foil 52 and a resin layer 54 laminated on each surface of the metal foil 52. The exterior body 50 is a metal laminate film that is obtained by coating the metal foil 52 on both sides with a polymer film (resin layer 54).

As the metal foil 52, for example, an aluminum foil can be used. For the resin layer 54, a polymer film such as polypropylene can be used. The material that constitutes the resin layer 54 may be different between the inner side and the outer side. For example, as a material of the outer side, a polymer having a high melting point, for example, polyethylene terephthalate (PET) or polyamide (PA) can be used, and as a material of the polymer film for the inner side, polyethylene (PE), polypropylene (PP), or the like can be used.

### <Terminal>

The terminals 60 and 62 are connected to the negative electrode 30 and the positive electrode 20, respectively. The terminal 62 connected to the positive electrode 20 is a positive electrode terminal, and the terminal 60 connected to the negative electrode 30 is a negative electrode terminal. The terminals 60 and 62 are responsible for the electrical connection to the outside and the power generation element 40. The terminals 60 and 62 are formed from a conductive material such as aluminum, nickel, copper, or the like. The connection method may be welding or screwing. The terminals 60 and 62 are preferably protected with an insulating tape to prevent short circuits.

### “Manufacturing Method for Lithium Ion Secondary Battery”

The lithium ion secondary battery 100 is produced by preparing the negative electrode 30, the positive electrode 20, the separator 10, the electrolytic solution, and the exterior body 50, and then assembling them. Hereinafter, one example of a manufacturing method for the lithium ion secondary battery 100 will be described.

First, the negative electrode 30 is produced. The negative electrode 30 is produced, for example, by sequentially carrying out a precursor solution production step, a slurry production step, an electrode coating step, a curing step, and a rolling step.

First, the precursor solution production step is carried out. First, a water-soluble polymer solution and a crosslinking precursor are prepared. An organic metal compound, which contains a metal that is capable of having a six-coordinate structure, is prepared as the crosslinking precursor. For example, an organic titanium compound or an organic zirconium compound, manufactured by Matsumoto Fine Chemical Co., Ltd., can be used as the crosslinking precursor.

The water-soluble polymer solution is such as one that is obtained by subjecting a part of carboxy groups to ion exchange. An aqueous solution of NaOH, Na₂CO₃, LiOH, Li₂CO₃, K₂CO₃, or the like is dropwise added to a polymer solution and stirred, whereby a part of the carboxy groups of the water-soluble polymer can be subjected to ion exchange. A cation contained in an aqueous solution of NaOH, Na₂CO₃, LiOH, Li₂CO₃, K₂CO₃, or the like neutralizes the carboxy group, and the proton of the carboxy group undergoes ion exchange with the cation.

Next, The water-soluble polymer solution and the crosslinking precursor are mixed to adjust the binder precursor solution. The mixing ratio between the water-soluble polymer solution and the crosslinking precursor is adjusted according to the constitution of the target binder.

Although it varies depending on the kind of water-soluble polymer, in a case of dissolving the water-soluble polymer in water, stirring is carried out for 1 hour or more at a temperature in a range of room temperature to 100° C. or lower. The rotation speed during stirring is set to 550 rpm or more and 1,500 rpm or less to carry out dissolution completely. After that, the crosslinking precursor is added to the water-soluble polymer solution, and stirring is carried out at room temperature for 5 minutes or more. The rotation speed during stirring is set to, for example, 180 rpm or more and 600 rpm or less. In a case where the crosslinking precursor is sufficiently dispersed in the water-soluble polymer solution, the crosslinking reaction can be allowed to proceed uniformly.

Next, the slurry production step is carried out. In the slurry production step, a negative electrode active material (silicon or silicon compound) and a conductive auxiliary agent are added to a precursor solution of the binder.

The solvent is, for example, water. The composition ratio between the negative electrode active material, the conductive auxiliary agent, and the binder precursor solution is, for example, 70 wt % to 99 wt %: 0 wt % to 10 wt %: 1 wt % to 20 wt % in terms of the mass ratio. The mass ratio thereof is adjusted so that the total is 100 wt %.

The negative electrode active material may be a negative electrode active material obtained by mixing active material particles and a conductive material while applying shear force and then allowing them to be formed into a composite. In a case where the active material particles are mixed by applying a shear force to the extent that the active material particles do not deteriorate, the surface of the active material particles is coated with the conductive material. In addition, the particle diameter of the negative electrode active material can also be adjusted according to the degree of this mixing. In addition, the negative electrode active material after production may also be sieved to have a uniform particle diameter.

Next, the electrode coating step is carried out. The electrode coating step is a step of coating the surface of the negative electrode current collector 32 with a slurry. The coating method for the slurry is not particularly limited. For example, a slit die coating method or a doctor blade method can be used as the coating method for the slurry.

Next, the curing step is carried out. In the curing step, the slurry is annealed. By annealing the slurry, the water-soluble polymer and the crosslinking precursor are crosslinked. In the curing step, the solvent is removed. The curing step is carried out, for example, in a nitrogen atmosphere. For example, the curing temperature is set to 120° C. or higher and 150° C. or lower. In addition, the temperature rising rate until reaching the curing temperature is set to, for example, 2° C./min or more and 5° C./min or less. In addition, the temperature decreasing rate after curing is set to, for example, 2° C./min or more and 5° C./min or less. By curing the binder under the above conditions, uneven distribution of crosslinking portions can be suppressed, and the crosslinking reaction can be allowed to proceed sufficiently.

The rolling step is carried out as necessary. The rolling step is a step of applying pressure to the negative electrode active material layer 34 to adjust the density of the negative electrode active material layer 34. The rolling step is carried out, for example, using a roll press device.

The positive electrode 20 can be produced according to the same procedure as the procedure for the negative electrode 30. As the separator 10 and the exterior body 50, commercially available ones can be used.

Next, the produced positive electrode 20 and negative electrode 30 are laminated so that the separator 10 is located between them, whereby the power generation element 40 is produced. In a case where the power generation element 40 is a wound body, the positive electrode 20, the negative electrode 30, and the separator 10 are wound around with one end side thereof as an axis.

Finally, the power generation element 40 is enclosed in the exterior body 50. The non-aqueous electrolytic solution is injected into the exterior body 50. After the non-aqueous electrolytic solution is injected, decompression, heating, or the like is carried out to impregnate the power generation element 40 with the non-aqueous electrolytic solution. Heat or the like is applied to seal the exterior body 50, whereby the lithium ion secondary battery 100 is obtained. It is noted that instead of injecting the electrolytic solution into the exterior body 50, the power generation element 40 may be immersed in the electrolytic solution.

The lithium ion secondary battery 100 according to the first embodiment has excellent cycle characteristics. This is considered to be because the binder 1 contained in the negative electrode active material layer 34 has high strength and high elasticity since it has a large network structure in which the water-soluble polymer 2 is crosslinked with the crosslinking agent 3. In addition, the binder 1 is strongly crosslinked by a metal-oxygen bond connecting the water-soluble polymer to the crosslinking agent, and thus it has high strength. In addition, the unreacted carboxy group in the binder interacts with the negative electrode active material and binds strongly to the negative electrode active material. That is, the lithium ion secondary battery 100 according to the first embodiment has excellent cycle characteristics since it has the binder 1 that is highly elastic and is capable of strongly binding to the negative electrode active material.

As described above, the embodiments according to the present invention have been described in detail with reference to the drawings. However, each of the configurations and the combination thereof in each embodiment are examples, and additions, omissions, substitutions, and other modifications of the configuration can be made without departing from the spirit of the present invention.

### EXAMPLES

### Example 1

First, as a base polymer, polyacrylic acid having a weight average molecular weight of 25,000 was prepared. Then, 60% of the carboxy group contained in the polyacrylic acid was subjected to ion exchange to substitute H of the carboxy group with Li. While the polyacrylic acid aqueous solution was stirred at 500 rpm, a LiOH aqueous solution was gradually added dropwise thereto to carry out ion exchange.

Next, a titanium lactate ammonium salt (manufactured by Matsumoto Fine Chemical Co., Ltd.: ORGATIX TC-335) was prepared as a crosslinking precursor.

Next, 100 parts by mass of the water-soluble polymers and water were added thereto, stirring was carried out at room temperature for 2 hours or more, and then the rotation speed during stirring was set to 550 rpm or more and 1,500 rpm or less, and stirring was carried out until the dissolution was completed. After that, 0.5 parts by mass of a crosslinking precursor was added to the water-soluble polymer aqueous solution.

The crosslinking reaction of the binder was carried out by raising the temperature at 5° C./min in a nitrogen atmosphere, keeping the resultant state at 150° C. for 3 hours, and decreasing the temperature at 5° C./h. In addition, before sintering, a binder precursor solution containing the crosslinking precursor and the water-soluble polymer aqueous solution was stirred at a rotation speed of 300 rpm for 30 minutes or more.

The liquid absorption rate of the produced binder was measured. The liquid absorption rate of the binder in Example 1 was 2%.

A negative electrode active material and a conductive auxiliary agent were added to a solution containing a binder, which was produced under the same conditions as the conditions for the sample of which the liquid absorption rate had been measured. The negative electrode active material used was SiOₓ that had been subjected to a disproportionation reaction by a heat treatment at 1,000° C. under reduced pressure. The conductive auxiliary agent used was Super-P (registered trademark). In addition, 25 g of a negative electrode active material, 1.4 g of a conductive auxiliary agent, and 13.5 g (concentration of solid contents: 10%) of a binder aqueous solution were mixed to adjust the coating solution (slurry). The total concentration of solid contents in the coating solution was set to 35 wt %. Next, the slurry was applied onto a copper foil as a negative electrode current collector with a doctor blade.

Next, the negative electrode current collector coated with the slurry was annealed in a nitrogen atmosphere. The annealing was carried out under such conditions that the temperature was raised at 5° C./min, the resultant state was kept at 150° C. for 2 hours, and the temperature was decreased at 5° C./min. The water-soluble polymer and the crosslinking agent were crosslinked to each other by annealing, and the slurry was cured. Then, the negative electrode current collector after curing of the slurry was subjected to rolling to form the negative electrode active material layer 34. Using a mold, punching was carried out into an electrode size of 22× 32 mm to create a negative electrode.

LiₓCoO₂ was used as the positive electrode active material. As the conductive auxiliary agent, Ketjen black was used. Polyvinylidene fluoride (PVDF) was used as the binder. N-methyl-2-pyrrolidone was used as the solvent. 96 parts by mass of the positive electrode active material, 2 parts by mass of the conductive auxiliary agent, 2 parts by mass of the binder, and 70 parts by mass of the solvent were mixed to produce a positive electrode slurry. In addition, the positive electrode slurry was applied onto one surface of an aluminum foil having a thickness of 15 μm, and the positive electrode active material layer 24 was formed by vacuum drying and rolling at 100° C. for 2 hours. Then, using a mold, punching was carried out into an electrode size of 22× 32 mm to produce a positive electrode.

Next, an electrolytic solution was produced. A solvent obtained by mixing at a mixing ratio of ethylene carbonate (EC):diethyl carbonate (DEC)=3:7 in terms of mass ratio was used as the solvent. LiPF₆ was used as the electrolytic salt. The concentration of LiPF₆ was set to 1 mol/L.

### (Production of Lithium Ion Secondary Battery for Evaluation)

The produced negative electrode and positive electrode were laminated with a separator (porous polyethylene sheet) interposed between them so that the positive electrode active material layer and the negative electrode active material layer faced each other, whereby a laminate was obtained. A nickel negative electrode lead was attached to the negative electrode of the laminate. An aluminum positive electrode lead was attached to the positive electrode of the laminate. The positive electrode lead and the negative electrode lead were welded with an ultrasonic welding machine. This laminate was inserted into an exterior body made of an aluminum laminate film, and the exterior body was subjected to heat sealing except for one place on the periphery thereof, whereby a hole-closing part was formed. Then, finally, the electrolytic solution was injected into the exterior body, and then the remaining one place was subjected to heat sealing while carrying out decompression with a vacuum sealer, whereby a lithium ion secondary battery was produced.

(Measurement of Capacity Retention Rate after 100 Cycles)

The cycle characteristics of the lithium ion secondary battery were measured. The cycle characteristics were measured using a secondary battery charging and discharging test device (manufactured by HOKUTO DENKO Corporation).

Charging was carried out by a constant current charging at a charging rate of 0.5 C (a current value at which charging is completed in 1 hour in a case where constant current charging is carried out at 25° C.) until the battery voltage reached 4.2 V, and then discharging was carried out by a constant current discharging at a discharging rate of 1.0 C until the battery voltage reached 2.5 V. The discharge capacity after the completion of the charging and discharging was detected to determine a battery capacity Q₁ before the cycle test.

Regarding the battery of which the battery capacity Q₁ had been determined as above, using again the secondary battery charging and discharging test device, charging was carried out by a constant current charging at a charging rate of 0.5 C until the battery voltage reached 4.2 V, and then discharging was carried out by a constant current discharging at a discharging rate of 1.0 C until the battery voltage reached 2.5 V. The above-described charging and discharging were counted as one cycle, and 100 cycles of charging and discharging were carried out. Thereafter, the discharge capacity after the completion of the 100 cycles of charging and discharging was detected to determine a battery capacity Q₂ after 100 cycles.

From the capacities Q₁ and Q₂ obtained as above, a capacity retention rate E after 100 cycles was calculated. The capacity retention rate E is calculated according to E=Q₂/Q₁×100. The capacity retention rate of Example 1 was 71%.

### Examples 2 to 4

Examples 2 to 4 differ from Example 1 in terms of the fact that the molecular weight of the base polymer of the water-soluble polymer was changed. Other conditions in Examples 2 to 4 were set to be basically the same as in Example 1, and then the liquid absorption rate and the capacity retention rate were determined. It is noted that, based on the difference between water-soluble polymers, the temperature condition and the like during manufacturing were adjusted.

### Examples 5 to 7

Examples 5 to 7 differ from Example 4 in terms of the fact that the ion exchange rate of the carboxy group of the polyacrylic acid, which is the base polymer of the water-soluble polymer, was changed. Other conditions in Examples 5 to 7 were set to be basically the same as in Example 4, and then the liquid absorption rate and the capacity retention rate were determined. It is noted that, based on the difference between water-soluble polymers, the temperature condition and the like during manufacturing were adjusted.

### Examples 8 to 13

Examples 8 to 13 differ from Example 4 in terms of the fact that the amount of the crosslinking precursors added to the water-soluble polymer aqueous solution was changed. The amount of the crosslinking precursors added to the water-soluble polymer aqueous solution corresponds to the mass ratio between the water-soluble polymer and the crosslinking agent in the binder. Other conditions in Examples 8 to 13 were set to be basically the same as in Example 4, and then the liquid absorption rate and the capacity retention rate were determined.

### Examples 14 to 18

Examples 14 to 18 differ from Example 4 in terms of the fact that the kind of crosslinking precursor was changed.

In Example 14, the crosslinking precursor used was a titanium lactate ammonium salt (manufactured by Matsumoto Fine Chemical Co., Ltd.: ORGATIX TC-300).

In Example 15, the crosslinking precursor used was titanium lactate (manufactured by Matsumoto Fine Chemical Co., Ltd.: ORGATIX TC-315).

In Example 16, the crosslinking precursor used was titanium triethanol aminate (manufactured by Matsumoto Fine Chemical Co., Ltd.: ORGATIX TC-400).

In Example 17, the crosslinking precursor used was titanium ethanol aminate (manufactured by Matsumoto Fine Chemical Co., Ltd.: ORGATIX TC-500).

In Example 18, the crosslinking precursor used was a zirconium lactate ammonium salt (manufactured by Matsumoto Fine Chemical Co., Ltd.: ORGATIX ZC-300).

Other conditions in Examples 14 to 18 were set to be basically the same as in Example 4, and then the liquid absorption rate and the capacity retention rate were determined. It is noted that, based on the difference between crosslinking agents, the temperature condition and the like during manufacturing were adjusted.

### Examples 19 and 20

Examples 19 and 20 differ from Example 4 in terms of the fact that the cation to be subjected to ion exchange was changed.

In Example 19, Na₂CO₃ was used to substitute H of the carboxy group with Na.

In Example 20, K₂CO₃ was used to substitute H of the carboxy group with K.

Other conditions in Examples 19 and 20 were set to be basically the same as in Example 4, and then the liquid absorption rate and the capacity retention rate were determined. It is noted that, based on the difference between water-soluble polymers, the temperature condition and the like during manufacturing were adjusted.

### Example 21

Example 21 differs from Example 20 in terms of the fact that the ion exchange rate of the carboxy group of the polyacrylic acid, which is the base polymer of the water-soluble polymer, was changed. Other conditions in Example 21 were set to be basically the same as in Example 20, and then the liquid absorption rate and the capacity retention rate were determined.

### Examples 22 to 37

Examples 22 to 37 differ from Example 4 in terms of the fact that the kind of crosslinking precursor was changed.

In Example 22, the crosslinking precursor used was a chromium lactate ammonium salt.

In Example 23, the crosslinking precursor used was chromium lactate.

In Example 24, the crosslinking precursor used was a chromium triethanol aminate.

In Example 25, the crosslinking precursor used was a chromium diethanol aminate.

In Example 26, the crosslinking precursor used was a manganese lactate ammonium salt.

In Example 27, the crosslinking precursor used was manganese lactate.

In Example 28, the crosslinking precursor used was manganese triethanol aminate.

In Example 29, the crosslinking precursor used was manganese diethanol aminate.

In Example 30, the crosslinking precursor used was a cobalt lactate ammonium salt.

In Example 31, the crosslinking precursor used was cobalt lactate.

In Example 32, the crosslinking precursor used was cobalt triethanol aminate.

In Example 33, the crosslinking precursor used was cobalt diethanol aminate.

In Example 34, the crosslinking precursor used was a nickel lactate ammonium salt.

In Example 35, the crosslinking precursor used was nickel lactate.

In Example 36, the crosslinking precursor used was nickel triethanol aminate. In Example 37, the crosslinking precursor used was nickel diethanol aminate.

Other conditions in Examples 22 to 37 were set to be basically the same as in Example 4, and then the liquid absorption rate and the capacity retention rate were determined. It is noted that, based on the difference between crosslinking agents, the temperature condition and the like during manufacturing were adjusted.

### Comparative Example 1

Comparative Example 1 differs from Example 4 in terms of the fact that the ion exchange rate of the carboxy group of the polyacrylic acid, which is the base polymer of the water-soluble polymer, was changed. In addition, all the carboxy groups were subjected to ion exchange. Other conditions in Comparative Example 1 were set to be basically the same as in Example 4, and then the liquid absorption rate and the capacity retention rate were determined.

### Comparative Example 2

Comparative Example 2 differs from Example 4 in terms of the fact that the carboxy group of the polyacrylic acid, which is the base polymer of the water-soluble polymer, was not subjected to ion exchange. Other conditions in Comparative Example 2 were set to be basically the same as in Example 4, and then the liquid absorption rate and the capacity retention rate were determined.

### Comparative Example 3

Comparative Example 3 differ from Example 4 in terms of the fact that the crosslinking precursor was not added. Other conditions in Comparative Example 3 were set to be basically the same as in Example 4, and then the liquid absorption rate and the capacity retention rate were determined.

The conditions and measurement results of Examples 1 to 37 and Comparative Examples 1 to 3 are summarized in Table 1 and Table 2. All of the crosslinking agents shown in Example 1 to Example 21 in Table 1 are those in terms of product names (ORGATIX), manufactured by Matsumoto Fine Chemical Co., Ltd. In addition, the adding amount of the crosslinking precursor in Table 1 and Table 2 corresponds to the parts by mass of the crosslinking agent per 100 parts by mass of the water-soluble polymer.

TABLE 1

| | | | | | Adding amount of | | |
|---|---|---|---|---|---|---|---|
| | | | | | crosslinking | | Capacity |
| | Water-soluble polymer | | | | precursor per 100 | | retention |
| | | Kind | | | parts by mass of | | rate |
| | | of | Substitution | Crosslinking | water-soluble polymer | Absorption | after 100 |
| | Base polymer | cation | rate | agent | (parts by mass) | rate (%) | cycles (%) |
| Example 1 | Polyacrylic acid (Mw~25,000) | Li⁺ | 60 | TC-335 | 0.5 | 2 | 71 |
| Example 2 | Polyacrylic acid (Mw~50,000) | Li⁺ | 60 | TC-335 | 0.5 | 4 | 84 |
| Example 3 | Polyacrylic acid (Mw~100,000) | Li⁺ | 60 | TC-335 | 0.5 | 7 | 85 |
| Example 4 | Polyacrylic acid (Mw~640,000) | Li⁺ | 60 | TC-335 | 0.5 | 8 | 91 |
| Example 5 | Polyacrylic acid (Mw~640,000) | Li⁺ | 40 | TC-335 | 0.5 | 12 | 54 |
| Example 6 | Polyacrylic acid (Mw~640,000) | Li⁺ | 80 | TC-335 | 0.5 | 5 | 79 |
| Example 7 | Polyacrylic acid (Mw~640,000) | Li⁺ | 95 | TC-335 | 0.5 | 6 | 63 |
| Example 8 | Polyacrylic acid (Mw~640,000) | Li⁺ | 60 | TC-335 | 0.05 | 11 | 61 |
| Example 9 | Polyacrylic acid (Mw~640,000) | Li⁺ | 60 | TC-335 | 1.6 | 3 | 86 |
| Example 10 | Polyacrylic acid (Mw~640,000) | Li⁺ | 60 | TC-335 | 2.3 | −3 | 81 |
| Example 11 | Polyacrylic acid (Mw~640,000) | Li⁺ | 60 | TC-335 | 3.1 | −5 | 74 |
| Example 12 | Polyacrylic acid (Mw~640,000) | Li⁺ | 60 | TC-335 | 9.8 | −5 | 67 |
| Example 13 | Polyacrylic acid (Mw~640,000) | Li⁺ | 60 | TC-335 | 10.2 | −7 | 61 |
| Example 14 | Polyacrylic acid (Mw~640,000) | Li⁺ | 60 | TC-300 | 0.8 | 9 | 79 |
| Example 15 | Polyacrylic acid (Mw~640,000) | Li⁺ | 60 | TC-315 | 0.7 | 11 | 75 |
| Example 16 | Polyacrylic acid (Mw~640,000) | Li⁺ | 60 | TC-400 | 0.9 | 8 | 81 |
| Example 17 | Polyacrylic acid (Mw~640,000) | Li⁺ | 60 | TC-500 | 0.1 | 5 | 83 |
| Example 18 | Polyacrylic acid (Mw~640,000) | Li⁺ | 60 | ZC-300 | 0.8 | 8 | 79 |
| Example 19 | Polyacrylic acid (Mw~640,000) | Na⁺ | 60 | TC-335 | 0.7 | 2 | 81 |
| Example 20 | Polyacrylic acid (Mw~640,000) | K⁺ | 60 | TC-335 | 0.6 | 4 | 87 |
| Example 21 | Polyacrylic acid (Mw~640,000) | K⁺ | 20 | TC-335 | 0.2 | 17 | 56 |

TABLE 2

| | | | | | Adding amount of | | |
|---|---|---|---|---|---|---|---|
| | | | | | crosslinking | | Capacity |
| | | | | | precursor per 100 | | retention |
| | Water-soluble polymer | | | | parts by mass of | | rate |
| | | Kind | | | water-soluble | | after 100 |
| | | of | Substitution | | polymer (parts | Absorption | cycles |
| | Base polymer | cation | rate | Crosslinking agent | by mass) | rate (%) | (%) |
| Example 22 | Polyacrylic acid (Mw~640,000) | Li⁺ | 60 | Aqueous solution of chromium | 0.5 | 7 | 64 |
| | | | | lactate ammonium salt | | | |
| Example 23 | Polyacrylic acid (Mw~640,000) | Li⁺ | 60 | Aqueous solution of chromium | 0.7 | 5 | 65 |
| | | | | lactate | | | |
| Example 24 | Polyacrylic acid (Mw~640,000) | Li⁺ | 60 | Aqueous solution of chromium | 0.9 | 7 | 62 |
| | | | | triethanol aminate | | | |
| Example 25 | Polyacrylic acid (Mw~640,000) | Li⁺ | 60 | Aqueous solution of chromium | 0.8 | 8 | 63 |
| | | | | diethanol aminate | | | |
| Example 26 | Polyacrylic acid (Mw~640,000) | Li⁺ | 60 | Aqueous solution of manganese | 0.6 | 9 | 62 |
| | | | | lactate ammonium salt | | | |
| Example 27 | Polyacrylic acid (Mw~640,000) | Li⁺ | 60 | Aqueous solution of manganese | 0.6 | 7 | 64 |
| | | | | lactate | | | |
| Example 28 | Polyacrylic acid (Mw~640,000) | Li⁺ | 60 | Aqueous solution of manganese | 1.2 | 8 | 61 |
| | | | | triethanol aminate | | | |
| Example 29 | Polyacrylic acid (Mw~640,000) | Li⁺ | 60 | Aqueous solution of manganese | 1.0 | 9 | 61 |
| | | | | diethanol aminate | | | |
| Example 30 | Polyacrylic acid (Mw~640,000) | Li⁺ | 60 | Aqueous solution of cobalt | 0.6 | 8 | 71 |
| | | | | lactate ammonium salt | | | |
| Example 31 | Polyacrylic acid (Mw~640,000) | Li⁺ | 60 | Aqueous solution of cobalt | 0.6 | 6 | 69 |
| | | | | lactate | | | |
| Example 32 | Polyacrylic acid (Mw~640,000) | Li⁺ | 60 | Aqueous solution of cobalt | 1.3 | 9 | 63 |
| | | | | triethanol aminate | | | |
| Example 33 | Polyacrylic acid (Mw~640,000) | Li⁺ | 60 | Aqueous solution of cobalt | 1.1 | 11 | 64 |
| | | | | diethanol aminate | | | |
| Example 34 | Polyacrylic acid (Mw~640,000) | Li⁺ | 60 | Aqueous solution of nickel | 0.7 | 8 | 68 |
| | | | | lactate ammonium salt | | | |
| Example 35 | Polyacrylic acid (Mw~640,000) | Li⁺ | 60 | Aqueous solution of nickel | 0.7 | 6 | 66 |
| | | | | lactate | | | |
| Example 36 | Polyacrylic acid (Mw~640,000) | Li⁺ | 60 | Aqueous solution of nickel | 1.3 | 11 | 65 |
| | | | | triethanol aminate | | | |
| Example 37 | Polyacrylic acid (Mw~640,000) | Li⁺ | 60 | Aqueous solution of nickel | 1.2 | 10 | 65 |
| | | | | diethanol aminate | | | |
| Comparative | Polyacrylic acid (Mw~640,000) | Li⁺ | 100 | TC-335 | 0.5 | 9 | 12 |
| Example 1 | | | | | | | |
| Comparative | Polyacrylic acid (Mw~640,000) | — | — | TC-335 | 0.3 | — | — |
| Example 2 | | | | | | | |
| Comparative | Polyacrylic acid (Mw~640,000) | Li⁺ | 60 | — | — | 13 | 43 |
| Example 3 | | | | | | | |

All of Examples 1 to 37 had excellent cycle characteristics as compared with Comparative Examples 1 to 3. On the other hand, Comparative Example 1 did not show sufficient cycle characteristics. This is considered to be because the reaction between the water-soluble polymer and the crosslinking agent has not proceeded sufficiently since the water-soluble polymer does not have a carboxy group in the binder in Comparative Example 1. In a case where the water-soluble polymer and the crosslinking agent do not react with each other, the binder cannot form a network structure, and thus high strength and high elasticity are not obtained. In addition, in Comparative Example 2, the binder underwent gelation, and thus the lithium ion secondary battery did not operate properly. It is considered that the binder in Comparative Example 2 underwent intramolecular crosslinking and gelation because the carboxy group of the water-soluble polymer was not subjected to ion exchange at all. In addition, Comparative Example 3 did not show sufficient cycle characteristics. It is considered to be because it was not possible to form a network structure having high strength and high elasticity since the binder in Comparative Example 3 did not have a crosslinking agent.

### REFERENCE SIGNS LIST

1 Binder
2 Water-soluble polymer
2A Carboxy group
2B COOX group
3 Crosslinking agent
4 Crosslinking precursor
10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium ion secondary battery

1. A cured product for a lithium ion secondary battery, comprising:
a water-soluble polymer that is crosslinked with a crosslinking agent,
wherein the water-soluble polymer has a carboxy group and a COOX group that is obtained by subjecting a part of carboxy groups to ion exchange, and
the crosslinking agent is a compound which contains a metal that is capable of having a six-coordinate structure.

2. The cured product for a lithium ion secondary battery according to claim 1, wherein the metal that is capable of having the six-coordinate structure is any one selected from the group consisting of titanium, zirconium, chromium, manganese, cobalt, and nickel.

3. The cured product for a lithium ion secondary battery according to claim 1, wherein the metal that is capable of having the six-coordinate structure is titanium or zirconium.

4. The cured product for a lithium ion secondary battery according to claim 1,
wherein an ion exchange rate of the water-soluble polymer is 50% or more and less than 90%, and
the ion exchange rate is defined as the ratio of the COOX groups to a total number of the carboxy group and COOX group.

5. The cured product for a lithium ion secondary battery according to claim 1, wherein the cured product for a lithium ion secondary battery contains 0.1 parts by mass or more and 10 parts by mass or less of the crosslinking agent with respect to 100 parts by mass of the water-soluble polymer.

6. The cured product for a lithium ion secondary battery according to claim 1, wherein a liquid absorption rate after immersion for a week in an electrolytic solution obtained by adding 1 mol/L of LiPF₆ to a non-aqueous solvent containing ethylene carbonate and diethyl carbonate is −5% or more and less than 15%.

7. A negative electrode for a lithium ion secondary battery, comprising:
a negative electrode active material; and
the cured product for a lithium ion secondary battery according to claim 1.

8. A lithium ion secondary battery comprising:
the negative electrode for a lithium ion secondary battery according to claim 7;
a positive electrode; and
a separator present between the negative electrode for a lithium ion secondary battery and the positive electrode.
